(19) United States
(12) Patent Application Publication
(10) Pub. No.: US 2003/0065556 A1
(43) Pub. Date: Apr. 3, 2003

(54) Vehicle dispatching system and vehicle dispatching processing apparatus

(75) Inventors: Taro Takanashi, Kawasaki (JP); Susumu Aoyama, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/096,646

(22) Filed: Mar. 14, 2002

(30) Foreign Application Priority Data
Sep. 28, 2001 (JP) 2001-303710

(51) Int. Cl. G06F 17/60

(52) U.S. Cl. 705/13

(57) ABSTRACT

A vehicle dispatching system for deciding, at a vehicle dispatching center, an appropriate taxi out of a plurality of taxis based upon a request for dispatching a vehicle, while reducing the monetary risks on the side offering the vehicles involved in dispatching the vehicles. The system comprises a communication unit for transmitting a request for dispatching a vehicle including the riding conditions; a vehicle dispatching center which makes reference to a service status data base storing the service status of the vehicles, and decides the dispatching of a vehicle that matches the riding conditions; and a bank organization which collects a charge involved in the dispatching of the vehicle before the vehicle selected to be dispatched arrives at a place where it was requested to dispatch the vehicle.

### BACKGROUND OF THE INVENTION

1. Field of the Invention

The present invention relates to a vehicle dispatching system and a vehicle dispatching processing apparatus for deciding, at a vehicle dispatching center, an appropriate taxi, out of a plurality of taxis, based upon a request for dispatching a vehicle, from a communication unit, to dispatch the vehicle.

2. Description of the Related Art

Related arts for requesting the dispatching of a vehicle such as a taxi by using a communication unit such as a mobile communication unit, e.g., a cellular phone or a PHS (personal handyphone system) have been disclosed in Japanese Unexamined Patent Publications (Kokai) Nos. 9-147160 and 2000-222690.

According to these prior arts, a customer who is going to request a dispatch sends a request for dispatch to a vehicle dispatching center by using his cellular phone. At the vehicle dispatching center, the most appropriate vehicle is selected, out of vehicles such as taxis, that have been registered in advance at the vehicle dispatching center, relying upon the customer information related to requesting the dispatch, dispatching conditions, present position information of the customer, desired destination, number of the passengers and the like.

The registered vehicles such as taxis are each provided with vehicle position detection means, and position information is sent to the vehicle dispatching center at suitable timings. Therefore, the vehicle dispatching center is allowed to select the most appropriate taxi based on the position information.

The vehicle dispatching center asks the driver of the selected taxi to make sure he can pick up the customer. When it is sure that the driver of the selected taxi can pick up the customer, the vehicle dispatching center informs the customer through his cellular phone of the estimated arrival time of the dispatched taxi and the car number, and dispatches the taxi.

According to the above-mentioned related art, the vehicle can be dispatched to the requested place. However, if the customer is not present at the requested place when the taxi has really arrived at that place, then, the cost of dispatching the taxi and the time are wasted.

A picking-up fare system has generally been employed for collecting the charge involved in dispatching the vehicle. When a requester calls for a taxi, the picking-up fare is charged separately from the riding fare. If there is no customer at the place to where it is requested to dispatch the taxi, then, the expected riding fare is not collected and, besides, the picking-up fare is not collected, either.

### SUMMARY OF THE INVENTION

It is therefore an object of the present invention to reduce the monetary risks, involved in dispatching the vehicles, to a person who offers the vehicles.

To attain the above object, a vehicle dispatching system according to the present invention comprises: a communication unit for transmitting a request for dispatching a vehicle inclusive of the riding conditions; a vehicle dispatching center which makes reference to a service status data base storing the service status of the vehicles, and decides the dispatching of a vehicle that is adapted to the riding conditions; and a bank organization which collects a charge involved in the dispatching of the vehicle before the dispatched vehicle arrives at the place where it is requested to dispatch the vehicle.

This system makes it possible to reduce the monetary risks, involved in dispatching the vehicles, to a person who offers the vehicles.

### BRIEF DESCRIPTION OF THE DRAWINGS

The above object and features of the present invention will be more apparent from the following description of the preferred embodiments given with reference to the accompanying drawings, wherein:

FIG. 1 is a block diagram illustrating the constitution of a vehicle dispatching system according to the present invention;

FIGS. 2A and 2B are flowcharts illustrating processing at a vehicle dispatching center;

FIG. 3 is a diagram illustrating a real-time service status DB;

FIG. 4 is a diagram illustrating a telephone number position DB;

FIG. 5 is a flowchart illustrating a first procedure for making a reservation of a taxi according to the present invention;

FIG. 6 is a flowchart illustrating a second procedure for making a reservation of a taxi according to the present invention (part 1);

FIG. 7 is a flowchart illustrating the second procedure for making a reservation of a taxi according to the present invention (part 2);

FIG. 8 is a diagram illustrating an example of a display on a screen for input reception;

FIG. 9 is a diagram illustrating an example of a screen displaying the results of provisional order (part 1);

FIG. 10 is a diagram illustrating an example of a screen displaying the results of provisional order (part 2); and

FIG. 11 is a diagram illustrating an example of a screen displaying the completion of dispatching a vehicle.

### DESCRIPTION OF THE PREFERRED EMBODIMENTS

Preferred embodiments of the present invention will be described below in detail while referring to the attached drawings.

The above-mentioned object of the present invention is accomplished by a vehicle dispatching system which comprises:

a communication unit for transmitting a request for dispatching a vehicle inclusive of the riding conditions;

a vehicle dispatching center which makes reference to a service status data base storing the service status of the vehicles, and decides the dispatching of a vehicle that is adapted to the riding conditions; and

a banking organ which collects a fee involved in the dispatching of the vehicle before the vehicle decided to be dispatched arrives at a place to where it was requested to dispatch the vehicle.

That is, according to the present invention, a request for dispatching a vehicle is received, a vehicle suited for the riding conditions is selected to be dispatched, and a charge involved in dispatching the vehicle or, concretely, a picking-up charge is collected before the vehicle selected to be dispatched arrives at the place to where it was requested to dispatch the vehicle. According to the present invention, the charge is collected early, so that at least the charge such as the picking-up charge involved in dispatching the vehicle is collected even in case that there is no requester at the place to where it is requested to dispatch the vehicle by the time the vehicle being dispatched has really arrived at the place.

An embodiment of the present invention will now be described with reference to the drawings.

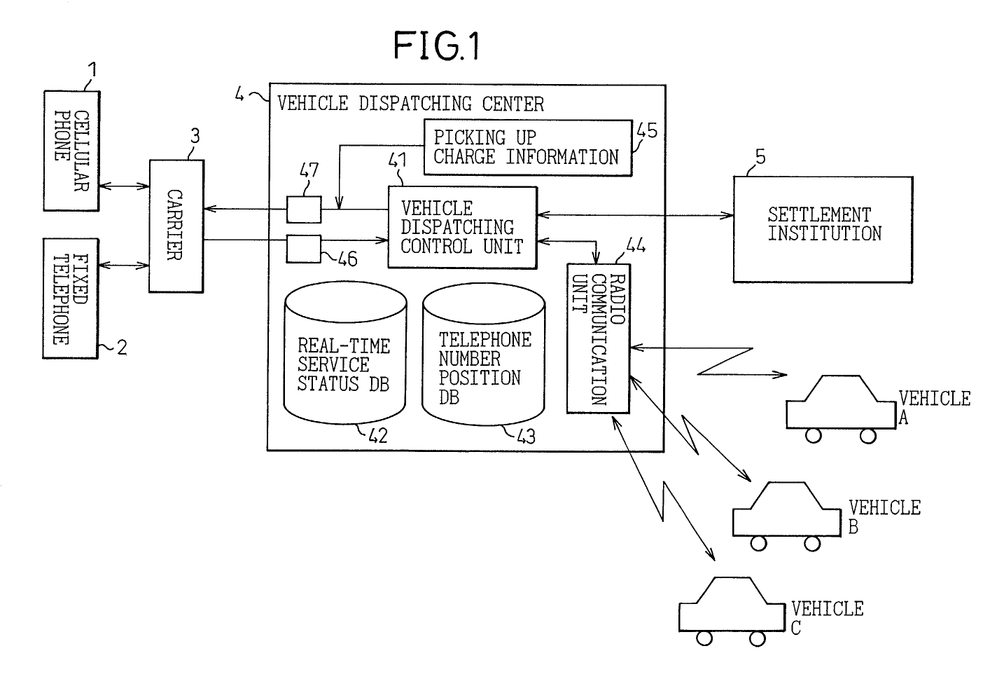

FIG. 1 is a block diagram illustrating the constitution of a vehicle dispatching system according to the present invention, and wherein reference numeral 1 denotes a mobile communication unit such as a cellular phone or a PHS. The cellular phone contains an internet connection service function that utilizes a widely known cellular phone network. The cellular phone 1 further contains a known GPS (global positioning system) receiver unit to pinpoint the location of the cellular phone 1 by utilizing signals from a GPS satellite orbiting the Earth, and further has a function for transmitting the pinpointed location.

Reference numeral 2 denotes a fixed telephone which is generally installed in a home or a shop, which is connected to a public telephone network or to an ISDN network, and is a dedicated fixed telephone capable of utilizing an internet connection service function belonging to general internet connection service functions using the above-mentioned cellular phone network.

Reference numeral 3 denotes a carrier which stands for a communications enterprise which owns a communication facility including a circuit network.

Reference numeral 4 denotes a vehicle dispatching center which is a management facility established in a taxi company.

The vehicle dispatching center 4 includes a receiver unit 46 for receiving a request for dispatching the vehicle from the cellular phone 1 through the carrier 3, a vehicle dispatching control unit 41 for deciding a vehicle to be dispatched based on the riding conditions in the request for dispatching the vehicle by making reference to the real-time service status DB 42 and to the telephone number position DB 43, a radio communication unit 44 which makes communication with the vehicles A to C, such as taxis, a register 45 for storing picking-up charge information related to the charge involved in dispatching the vehicle, and a transmitter unit 47 which, after the vehicle to be dispatched has been selected, informs the cellular phone 1 of the dispatch of the vehicle including the picking-up charge information. The vehicle dispatching control unit 41 is capable of exchanging information with a settlement institution 5 such as a bank in order to charge the picking-up fare.

The vehicles A to C such as taxis are each provided with a known GPS (global positioning system) receiver unit to pinpoint their present positions by using the signals from a GPS satellite orbiting the Earth and to transmit their present positions.

It is desired that the picking-up charge information stored in the register 45 is a charge obtained by multiplying a prescribed picking-up charge by a predetermined reduction rate. On the side of customers, they are allowed to enjoy a monetary merit of a reduced picking-up charge rather than a usual charge that they would have to pay.

As for the vehicle dispatching center which offers the vehicle, the picking-up charge can be collected though the charge is reduced to some extent, creating a monetary merit as compared to when the picking-up charge is not collected, despite visiting the place to where it is requested to dispatch the vehicle, because of the absence of the customer. Besides, the vehicle dispatching center is allowed to dispatch the vehicles systematically offering an advantage of covering the pick-up charge at the reduced rate with the riding fare.

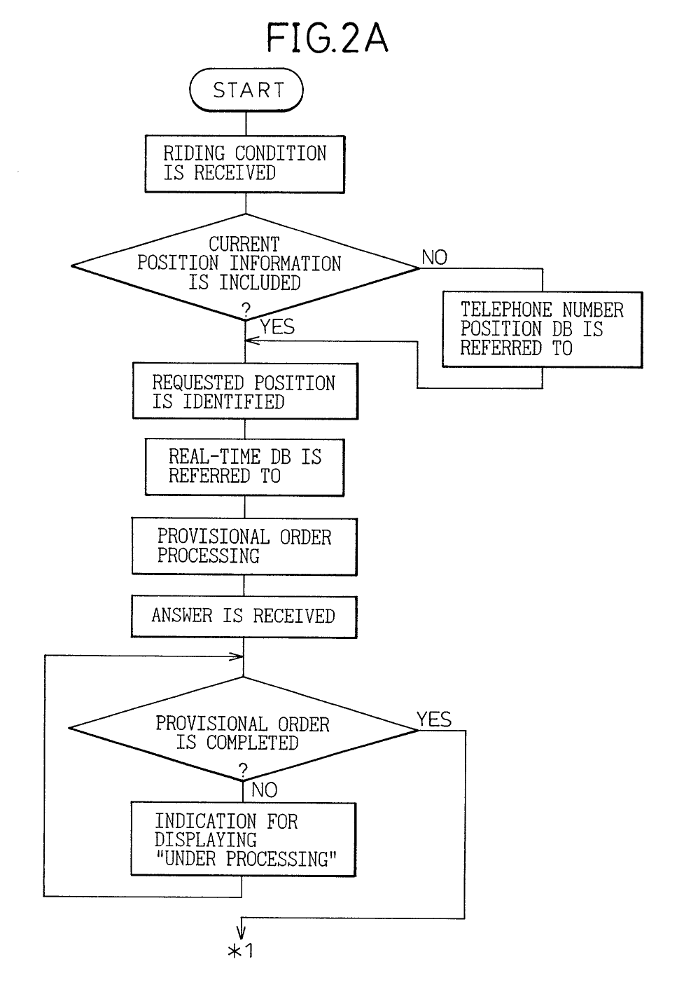

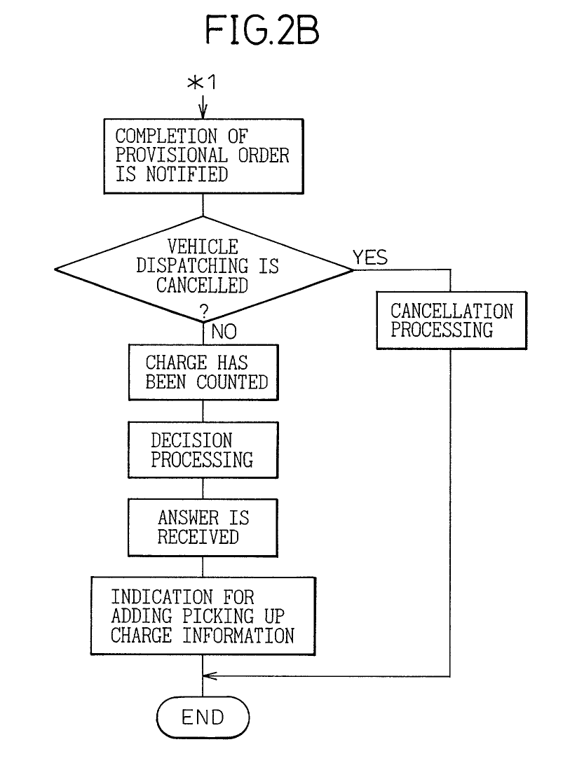

FIGS. 2A and 2B are flowcharts illustrating processing at the vehicle dispatching center. Riding conditions are received by the receiver unit 46 from the requester through the cellular phone or the fixed telephone. It is judged whether present position information is included in the received information. When the present position information is included, the requested position is pinpointed. When the present position information is not included, the requested position is pinpointed by making reference to the telephone number position DB 43.

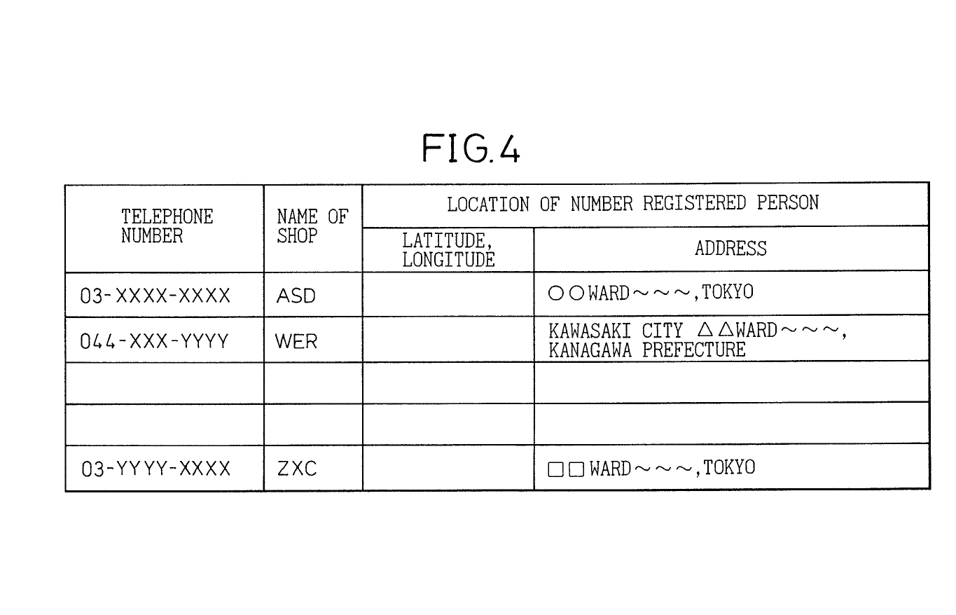

If the requester sends the request for dispatching the vehicle by using the cellular phone equipped with the GPS, then, the position information is included in the riding condition in the request for dispatching the vehicle. If the request for dispatch is sent from the fixed telephone, on the other hand, the position information is not included. Therefore, the position is pinpointed by using the telephone number position DB 43 as shown in FIG. 4.

The telephone number position DB 43 stores the names of shops and the locations of persons whose numbers have been registered, that are allocated to the telephone numbers. The locations of persons whose numbers have been registered include latitudes, longitudes and addresses. If a request for dispatching the vehicle is transmitted from a fixed telephone of a telephone number of, for example, 03-xxxx-xxxx, then, reference is made to the DB 43 to pinpoint the shop name (asd), latitude, longitude, and the address ( - - - , - - - WARD, TOKYO).

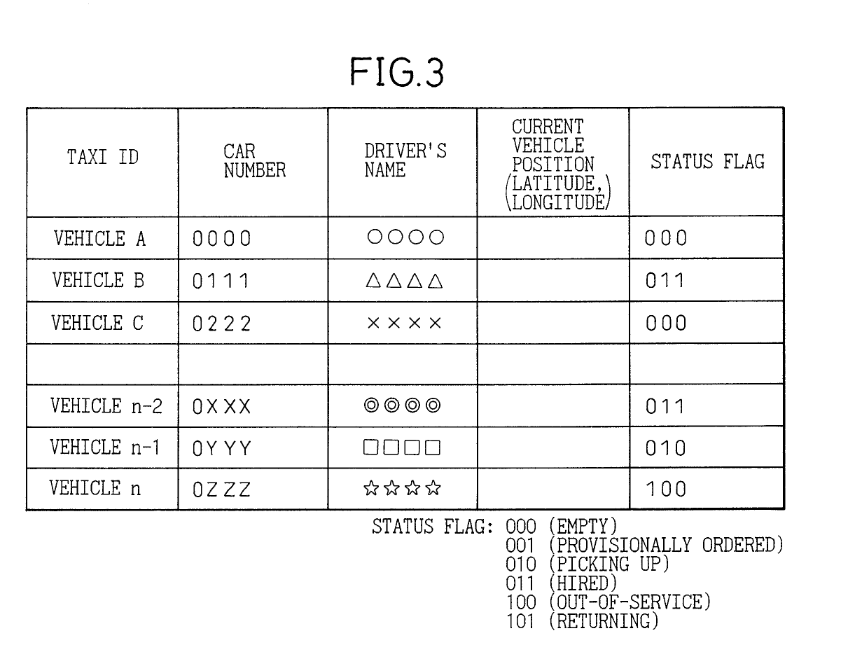

When the customer's position is pinpointed, processing is executed to select the vehicle that is to be dispatched to the requester by making reference to the real-time service status DB 42. As shown in FIG. 3, the real-time service status DB stores the car numbers, names of the drivers, current vehicle positions (latitudes, longitudes) and status flags, that are allocated to the taxi IDs.

The status flags identify, depending upon the codes thereof, the statuses of the vehicles belonging to the vehicle dispatching center 4. The status flag “000” of the vehicle A and the vehicle C represents that they are empty and are running about the city. The status flag “011” of the vehicle B and the vehicle n−2 represents that they are hired and are traveling toward their destinations carrying passengers.

The flag “010” of the vehicle n−1 represents that the vehicle is in a picking-up state and is traveling toward the customer's location or toward the place specified by the customer as called by the customer to pick up the customer. The status flag “100” of the vehicle n represents that the vehicle is in an out-of-service state and is returning to its home office after having finished the work of that day. The status flag “001” represents that the vehicle is in a standby state waiting for a call of a final decision from the vehicle dispatching center to pick up a customer. The status flag “101” represents a state where the vehicle that has ended the work is in the garage of its home office.

Next, a provisional order processing is executed to dispatch the vehicle to the requester. In the provisional order processing, an order is announced from the radio communication unit 44 to the vehicles that can be dispatched while making reference to the current vehicle positions and the status flags in the real-time service status DB 42, and the vehicles that can be dispatched send back a reply if they can be dispatched. If there is a vehicle that can be dispatched, the status flag in the real-time service status DB 42 is updated. Concretely speaking, the flag “000”, is updated to flag “001”.

After the completion of the provisional order processing, the requester is informed of the provisional order. If the provisional order has not been completed, an instruction is issued to display “under processing” to the customer. If the requester does not cancel the dispatching of the vehicle after he has been informed of the result of the provisional order, it is then so regarded that the provisional order is effective, and the charge calculation processing is executed between the vehicle dispatching control unit 41 and the settlement institution 5.

The charge count stands for a collection of the picking-up charge. The picking-up charge is usually called an “initial charge”. Here, if the charge is discounted to some extent, the requester feels a monetary merit. Even from the side of the vehicle dispatch operator, since the pick-up charge can be collected without failure and, therefore, it offers a monetary merit despite the above discount.

After the completion of the charge count processing, the processing is, then, executed for selecting the vehicle to be dispatched based on the provisional order processing of the vehicle. The vehicle which is selected to be dispatched is, then, informed of the notice of decision and information such as requester's name, requester's present position, destination and the like, through the radio communication unit 44. After a reply is finally obtained from the vehicle which is selected to be dispatched and the vehicle can be dispatched, the vehicle is, then, instructed to go and pick up the requester. At the same time, the status flag in the real-time service status DB 42 is updated. Concretely speaking, the flag “001” is updated to flag “010”.

Thereafter, processing is executed to add the picking-up charge information to the notice of decision of dispatching the vehicle to the requester, and the requester is informed of the notice and information through the transmitter unit 47. This notice is sent to the cellular phone of the requester before the vehicle selected to be dispatched arrives at the requested place, i.e., before the vehicle for picking up arrives at the place to where it is requested to dispatch the vehicle.

If the requester cancels the dispatching of the vehicle, on the other hand, it is so regarded that there existed no provisional order, the vehicle to be dispatched is informed of this fact, and the status flag in the real-time service status DB 42 is updated from the flag “001”, to the flag “000”.

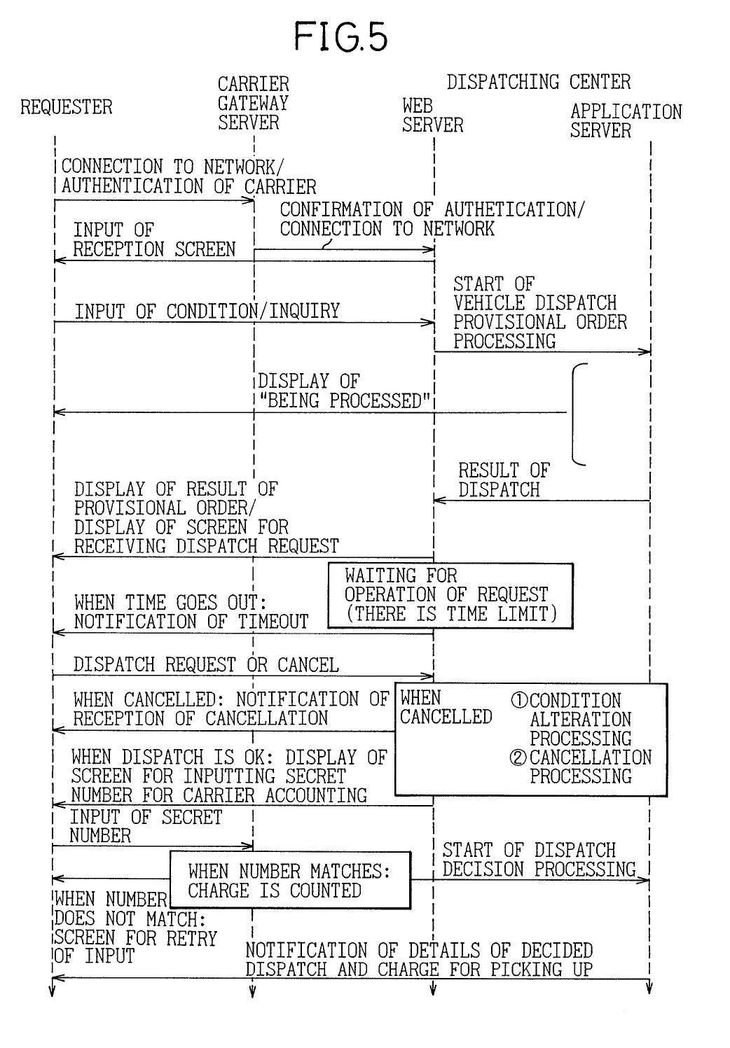

Next, described below with reference to FIG. 5 is a first procedure for making a reservation of a taxi according to the present invention. In this embodiment, it is presumed that a requester who is a customer makes a request for dispatching a vehicle by using his cellular phone equipped with the GPS.

In FIG. 5, the carrier is equipped with a gateway server. The vehicle dispatching center is provided with a web server for exchanging information by using the gateway server of the carrier and an open line network such as the Internet, and an application server connected to the web server via the dedicated line. The vehicle dispatching center is located within the taxi company. A secured communication is effected between the carrier and the cellular phone or the fixed telephone, and, similarly, between the carrier and the vehicle dispatching center.

The requester who requests the dispatching of a vehicle, first, connects the network to the carrier and authenticates the carrier by using his cellular phone equipped with the GPS. The carrier confirms the authentication and, if there is no problem, connects the network to the web server in the vehicle dispatching center, and the web server displays the reception on the screen of the customer's cellular phone. Thus, a communication network is established between the requester and the vehicle dispatching center.

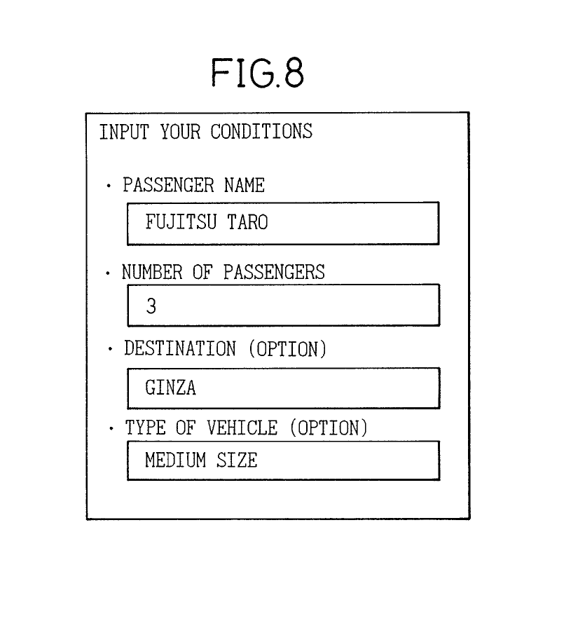

The requester operates his cellular phone to input the riding conditions by hand. FIG. 8 shows an example of a screen of input. There are input, for example, the name of the customer, number of customers (passengers) and, optionally, destination and the type of vehicle, which are, then, transmitted. The riding conditions including the data input as described above and the present position information of the requester input by utilizing the GPS function of the cellular phone, are transmitted to the web server as a request for dispatching a vehicle.

Upon receipt of the request for dispatching the vehicle at the vehicle dispatching center, a provisional order processing of a vehicle dispatch is executed by the application server. Concretely speaking, the processing is executed, such as making reference to the real-time service status DB, making sure whether the vehicle to be dispatched can pick up the customer, selecting the vehicle to be dispatched provisionally, and updating the flag in the real-time service status DB relying upon the flowchart of the processing at the vehicle dispatching center shown in FIGS. 2A and 2B. During this period, “under processing” is displayed on the screen of the requester's cellular phone.

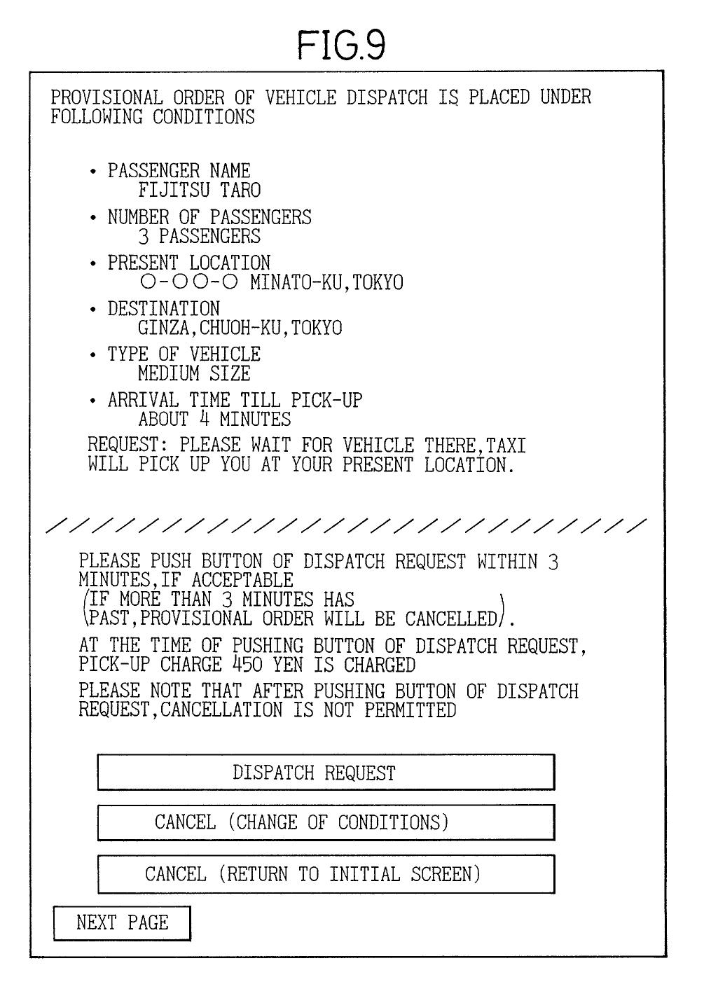

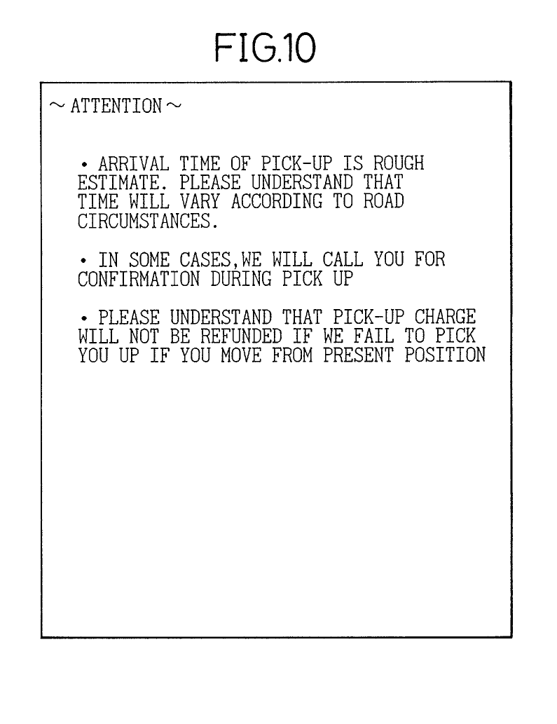

When the provisional order is completed, the results of provisional order are displayed as shown in FIG. 9 and FIG. 10, i.e., passenger name, number of passengers, present location, destination, type of vehicle, and arrival time for pick-up are notified. The display of results of the provisional order also serves as a screen for receiving the request for dispatching a vehicle.

Namely, a push button is provided in the lower part of the display screen, and the dispatch is finally requested upon depressing the push button after the requester has agreed with the results of the provisional order. FIG. 10 is a continuation of FIG. 9, and is a screen notifying matters that require attention in connection with the provisional order.

The requester depresses the button for requesting the dispatch within 3 minutes when he agrees with the content of the provisional order, or depresses the cancel button when he wishes to cancel the request. If the time of 3 minutes elapses, the result is the time-out and the provisional order is automatically cancelled. The words “Three minutes have passed, and provisional order is cancelled” are displayed on the requester's cellular phone.

When cancellation is received, there can be done either one of two things. The first one is to change the conditions and try again the provisional order. In this case, the requester inputs the riding conditions again. The second one is to so regard that there was no provisional order and the order is invalidated, and the display returns to the initial screen.

When the request of dispatch is finally sent from the requester, a display is made on the screen to input a secret number for charging the fare so as to count the fare involved in the dispatch, i.e., the pick-up fare. The requester inputs his secret number, and the gateway server executes the authentication processing concerning if it is in agreement. When it is in agreement, the charge is counted. If the secret number is not in agreement, the requester is permitted to input his secret number again a few more times. If the secrete number is not still in agreement, the provisional order is cancelled.

In the embodiment of FIG. 5, the charge is counted by utilizing the settlement by the carrier. Namely, the picking-up charge is added to the monthly payment inclusive of the usage rate of the cellular phone, so as to be paid later at one time. When the charge is counted, a processing is executed for deciding the dispatching of a vehicle. The vehicle which is selected to be dispatched is informed of the notice of finally deciding the dispatch, customer's name, customer's present location, as well as such data as destination and the like.

If the vehicle that is finally selected has a car navigation system, then, the requester's present location is set to the car navigation system, and the driver of the vehicle is allowed to smoothly travel to the requester's present position or to a position where the customer can be picked up.

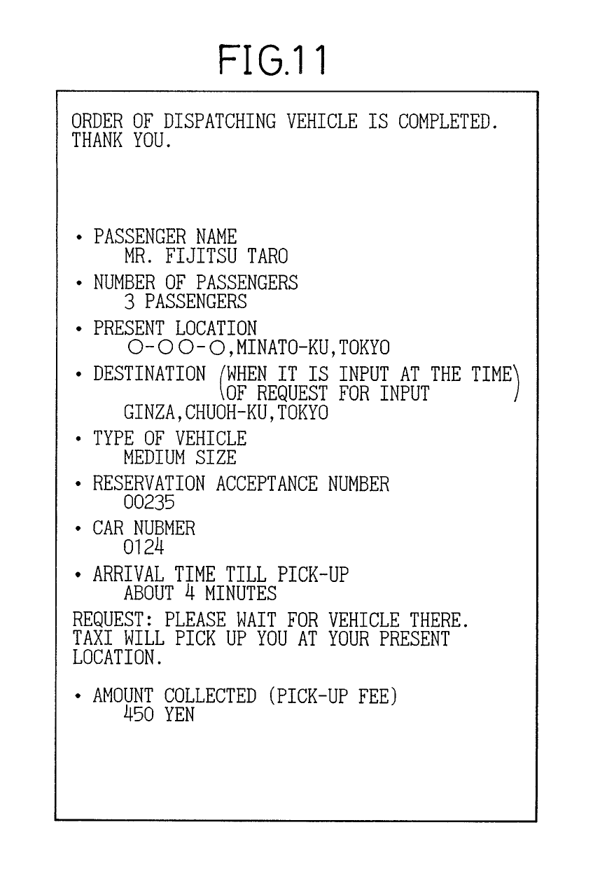

A display of completion of the vehicle dispatching illustrated in FIG. 11 is shown on the screen of the requester's cellular phone. On this screen is displayed in detail information concerning the order of dispatching the vehicle as well as the amount of the picking-up charge as the amount of already paid charge. This is displayed on the requester's cellular phone before the vehicle that is selected to be dispatched arrives at the place to where it was requested to dispatch the vehicle, i.e., before the vehicle for picking up the customer arrives at the place to where it is requested to dispatch the vehicle.

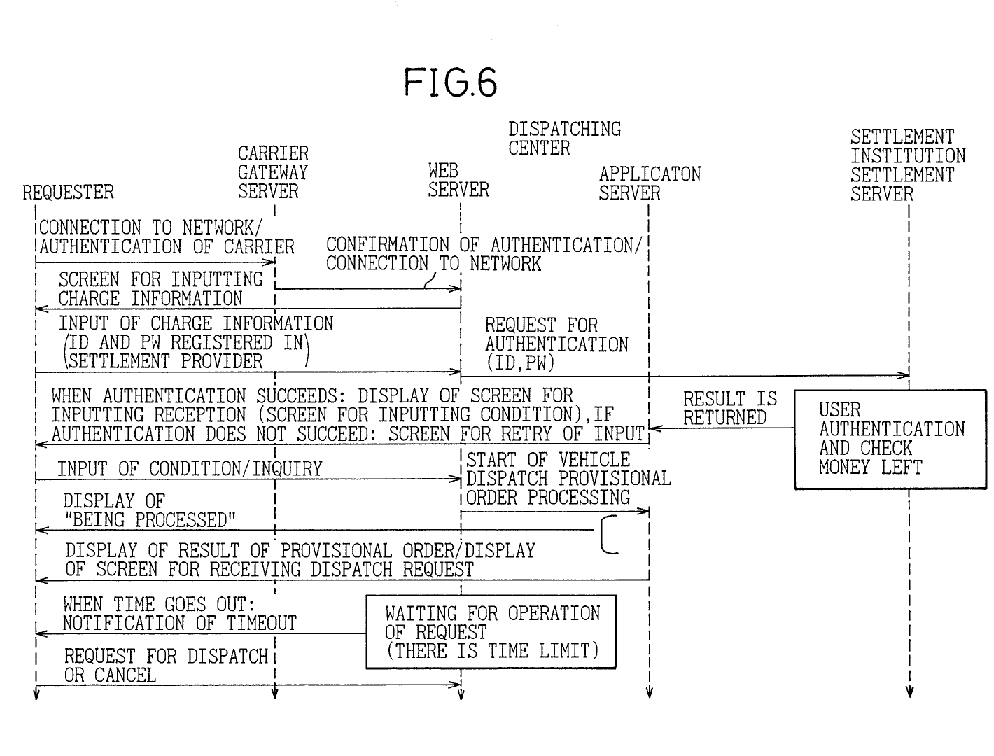

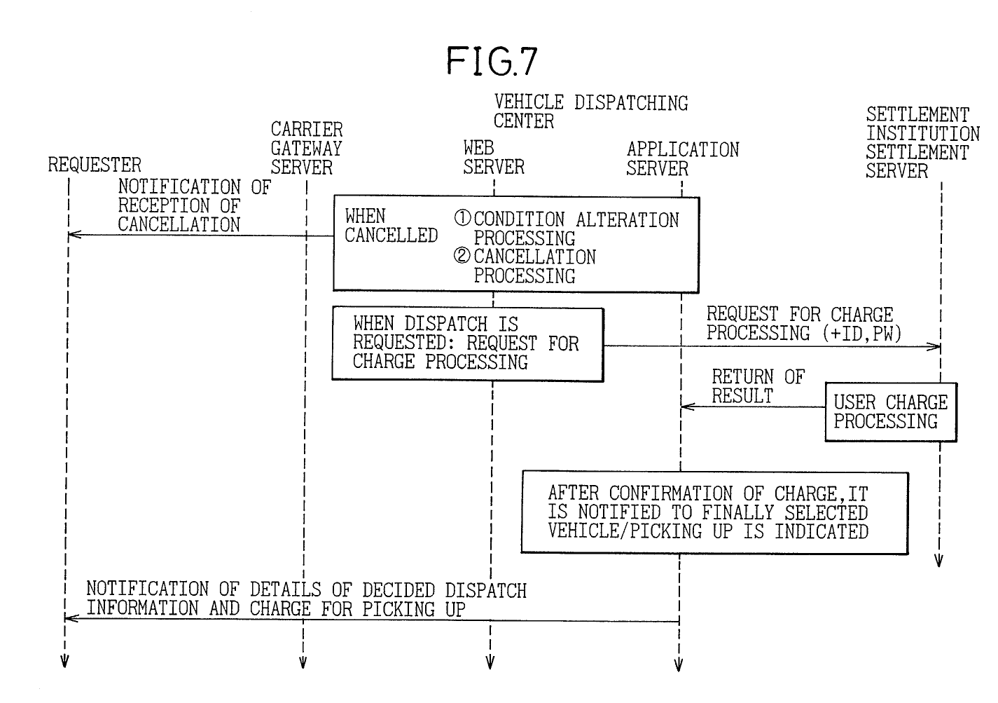

Next, a second procedure for making a reservation of a taxi according to the present invention will be described with reference to the flowcharts of FIGS. 6 and 7. In this embodiment, it is presumed that the requester who is a customer requests a vehicle by using a cellular phone equipped with the GPS.

In FIGS. 6 and 7, the carrier is equipped with a gateway server. The vehicle dispatching center is provided with a web server for exchanging information by using the gateway server of the carrier and an open line network such as the Internet, and an application server connected to the web server via the dedicated line. The vehicle dispatching center is located within the taxi company. A secured communication is carried out between the carrier and the cellular phone or the fixed telephone, and, similarly, between the carrier and the vehicle dispatching center. The secured communication is further carried out between the vehicle dispatching center and the settlement institution.

The requester who requests the dispatching of a vehicle, first, connects with the carrier via the network and the carrier effects the authentication using his cellular phone equipped with the GPS. The carrier confirms that authentication and, if there is no problem, connects it to the web server in the vehicle dispatching center via the network, and the web server displays the charge information on the screen of the customer's cellular phone.

The requester operates his/her cellular phone to input authentication information which includes a contractor ID and a password PW registered to the settlement provider, and which is used as charge information as well. The web server requests the settlement server to execute the authentication. The settlement server authenticates the user, checks the balance in the account, and returns the results to the application server. When there is no problem as a result of checking the balance in the account and when the authentication has succeeded, the riding conditions are input from the requester's cellular phone.

When the conditions determined by the settlement institution are not satisfied such as shortage in the balance in the account, the subsequent processing is not executed; i.e., the processing ends. When the authentication processing has failed despite the balance in the account is not deficient, the screen for retry of input is displayed on the requester's cellular phone so that he may retry to input the request. If the authentication does not succeed despite retrying a few times, the processing ends at that moment.

When the authentication has succeeded without any problem in the settlement conditions such as balance in the account, the requester operates his/her cellular phone to input the riding conditions. FIG. 8 illustrates an example of a screen for that input. There are input, for example, the name of the customer, number of customers (passengers) and, optionally, the destination, which are, then, transmitted. The riding conditions including the data input as described above and the present position information of the requester input by utilizing the GPS function of the cellular phone, are transmitted to the web server as a request for dispatching a vehicle.

Upon receipt of the request for dispatching the vehicle at the vehicle dispatching center, a provisional order processing of a vehicle dispatch is executed by the application server. Concretely speaking, processing is executed, such as making reference to the real-time service status DB, making sure whether the vehicle to be dispatched can pick up the customer, deciding the vehicle to be dispatched provisionally, and updating the flag in the real-time service status DB relying upon the flowchart of the processing at the vehicle dispatching center shown in FIGS. 2A and 2B. During this period, “under processing” is displayed on the screen of the requester's cellular phone.

When the provisional order is completed, the results of provisional order are displayed as shown in FIG. 9 and FIG. 10, i.e., passenger name, number of passengers, present location, destination, type of vehicle, and arrival time till pick-up are notified. The display of results of the provisional order also serves as a screen for receiving the request for dispatching a vehicle. Namely, a push button is provided in the lower part of the display screen, and the dispatch is finally requested upon depressing the push button after the requester has agreed with the results of the provisional order. FIG. 10 is a continuation of FIG. 9, and shows a screen notifying matters that require attention in connection with the provisional order.

The requester depresses within 3 minutes the button for requesting the dispatch when he agrees with the content of the provisional order, or depresses the cancel button when he wishes to cancel the request. If the time of 3 minutes elapses, the result is the time-out and the provisional order is automatically cancelled. The words “Three minutes have passed, and provisional order is cancelled” are displayed on the requester's cellular phone.

When cancellation is received, there can be done either one of two things. The first one is to change the conditions and try again the provisional order. In this case, the requester inputs the riding conditions again. The second one is to so regard that there was no provisional order and the order is invalidated, and the display returns to the initial screen.

When the request of dispatch is finally sent from the requester, the settlement server is requested to calculate the charge in order to charge the fee involved in dispatching the vehicle, i.e., the picking-up charge. Based on the contractor ID sent from the web server and used for the authentication and the contractor ID in the password PW, the settlement server executes the user charge processing to collect the picking-up charge from the contractor's account.

The results are returned back to the application server. After having confirmed the collection of charge, the application server executes the processing for deciding the dispatch of the vehicle, i.e., informs the vehicle which is selected to be dispatched of the notice of finally deciding the dispatch, customer's name, customer's present location, as well as such data as destination and the like, and instructs the vehicle to pick up the customer. In the embodiments of FIGS. 5 and 7, the dispatching of the vehicle is finally ordered after the payment of the picking-up charge has really been completed by the settlement server.

If the vehicle that is finally selected has a car navigation system, then, the requester's present location information is set to the car navigation system, and the driver of the vehicle is allowed to smoothly travel to the requester's present position or to a position where the customer can be picked up.

A screen of the completion of the vehicle dispatching shown in FIG. 11 is displayed on the requester's cellular phone. On this screen is displayed in detail information concerning the order of dispatching the vehicle as well as the amount of the picking-up charge as the amount of already paid charge. This is displayed on the requester's cellular phone before the vehicle that is decided to be dispatched arrives at the place to where it is requested to dispatch the vehicle, i.e., before the vehicle for picking up the customer arrives at the place to where it is requested to dispatch the vehicle.

In the above-mentioned embodiment, the requester requests the dispatching of a vehicle by using his cellular phone equipped with the GPS. However, the communication unit which the requester uses is not always the cellular phone with the GPS. The requester may use, for example, a PHS, a fixed telephone capable of receiving an Internet connection service, a personal computer incorporating a communication card module or a communication card set into a PC slot, or a PDA (personal digital assistant).

Information related to the position of the vehicle for picking up may be notified to the requester to offer improved service for the requester. This is a service for letting the requester know where the vehicle for picking up is now running relative to the requester's present position by transmitting information related to the position of the vehicle for picking up to the requester's cellular phone at regular time intervals, e.g., every after 30 seconds in addition to letting the requester know, as a notice of final decision, a rough period of time until the vehicle will arrive to pick the customer up.

As described above, the present invention makes it possible to reduce the monetary risks involved in dispatching the vehicles to the person who offers the vehicles. It is further made possible to decrease the cost of dispatching the vehicles and to offer a quick service for the customers who are the requesters.

What is claimed is:

1. A vehicle dispatching system comprising:
a communication unit for transmitting a request for dispatching a vehicle inclusive of the riding conditions;
a vehicle dispatching center which makes reference to a service status data base storing the service status of the vehicles, and decides the dispatching of a vehicle that matches the riding conditions; and
a bank organization which collects a charge involved in the dispatching of the vehicle before the vehicle decided to be dispatched arrives at a place to where it is requested to dispatch the vehicle.

2. A vehicle dispatching processing apparatus comprising:
a reception unit for receiving a request for dispatching a vehicle inclusive of the riding conditions from a communication unit;
a vehicle dispatching control unit which makes reference to a service status data base storing the service status of the vehicle, and decides the dispatching of a vehicle that matches the riding conditions; and
a transmission unit for transmitting, to a communication unit, the collection of a charge involved in the dispatching of a vehicle before the vehicle that is selected to be dispatched arrives at a place where it was requested to dispatch the vehicle.

3. A vehicle dispatching processing apparatus according to claim 2, wherein said charge is a picking-up fee.

4. A computer readable storage medium containing instructions comprising:
receiving, at a reception unit, a request for dispatching a vehicle inclusive of the riding conditions from a communication unit;
making reference, at a vehicle dispatching control unit, to a service status data base storing the service status of the vehicle and deciding the dispatching of a vehicle that matches the riding conditions; and
transmitting, at a transmission unit, an information, to a communication unit, of the already paid charge involved in the dispatching of a vehicle before the vehicle that is decided to be dispatched arrives at a place to where it is requested to dispatch the vehicle.

5. A computer program product for use in conjunction with a computer, the computer program product comprising:
a reception control program, at a reception unit, for receiving a request for dispatching a vehicle inclusive of the riding conditions from a communication unit;
a vehicle dispatching control program, at a vehicle dispatching control unit, for making reference to a service status data base storing the service status of the vehicles and deciding the dispatching of a vehicle that is adapted to the riding conditions; and
a transmission control program, at a transmission unit, for transmitting an information, to a communication unit, of the already paid charge involved in the dispatching of a vehicle before the vehicle that is selected to be dispatched arrives at a place where it was requested to dispatch the vehicle.
